(19) United States
(12) Patent Application Publication
(10) Pub. No.: US 2007/0163400 A1
(43) Pub. Date: Jul. 19, 2007

(54) Percussion instrument adjustment and tuning tool

(76) Inventor: Frank D. Parise, San Jose, CA (US)

Correspondence Address: Walt Froloff, 273D Searidge Rd, Aptos, CA, 95003, US

(21) Appl. No.: 11/637,282

(22) Filed: Dec. 12, 2006

Related U.S. Application Data
(60) Provisional application No. 60/759,507, filed on Jan. 17, 2006.

(51) Int. Cl. B25B 13/48; B25B 13/56; B25B 13/00

(52) U.S. Cl. 81/176.1; 81/121.1; 81/124.3; 81/124.7

(57) ABSTRACT

The present invention is an combination drum/percussion hardware wig nut tightening/loosening tool and tuning key. It is comprised of a cylinder body, with two sets of open slots at one end for wing nut adjustments. One end of the cylindrical body comprises protruding socket slots designed to engage wing nuts of various sizes for rapid but sensitive adjustments. The other end of the cylinder tapers down in diameter to a socket style wrench. The socket style wrench end can be used for tuning heads on standard percussion instruments such as congas, bongos, timbales, etc, and for tightening and loosening various nuts and bolts through out the musical industry world. A slidable coupled cross center rod, can be round, oval, hexagon, octagon and others forms, is guided thru the cylinder body midsection, at an angle adjustable for maximum leverage in confined spaces. The cross center rod also has a counter sunk square hole at one end that can be fitted on any standard musical drum lug nut so one can tune drum heads, as well as, tighten and loosen any and all same size, square headed nuts and bolts through out the drum and percussion world.

### BACKGROUND

1. Field of the Invention

The present invention generally relates to socket wrench tools for loosening and tightening wing nuts, bolts and screws and in particular a single combination tool for percussion instrument adjustment and tuning.

2. Background

Wing nuts have long been employed to provide convenient and rapid mechanical advantage for tightening and loosening bolts without the use of a standard nut, one that would require the use of a box or open end wrench because finger-hand strength would be insufficient. Wing nuts alleviate some of this by allowing fingers purchase on the nut for loosening and tightening. However, it has long been recognized by percussion instrumentalists and musicians, standard conventional wing nuts typically have limited leverage or turning power with fingers in the close quarter kinds of uses required by certain percussion instruments and a critical shortcoming this is because makeshift alternatives can cause costly damage to expensive instruments. The musical industry percussion instruments suffer from a lack of device or tool to act as a “wench and/or key” that would allow the user to achieve more leverage-in the tightening or loosening of wing nuts and adjusting tuning bolts.

Moreover, the musical instrument industry in particular use wing nuts for musical stands of the kind designed for folding stands and multi functional hardware stands, adaptors and clamps in the drum and percussion environment including but not limited to cowbells, wood blocks, and accessory instruments. The tuning of standard drum heads, conga, bongo and timbale heads also requires fasteners, tighteners, wing nuts and hand and forearm leverage to secure and adjust instruments and accessories in tight quarters to just the correct setting without over tensioning.

Because of the general lack of anything better, technicians, drummers, percussionists, and artists are forced to use makeshift solutions using hands and pliers to adjust wing nuts to achieve secure tightened tension. This may lead to not only partial destruction of the wing nuts from gripping the wing nuts with pliers, but even stripping either the bolt or wing nut. This need cries out for a pocket size tool or key that would slip over the wing nuts and allow the artist, musician or user to achieve maximum leveraged, and secured tightness with much less effort and little to no damage to both the wing nuts, not to mention pain to the artist's hands, during a tightening or loosening procedure.

Efforts to solve this problem have been addressed by some manufactures by enlarging the wing nuts, which many times is effective in tightening the wing nuts but many times leads to the wing nuts being over tightened such that the user is required again to resort to pliers to loosen the wing nuts and again subject the wing nuts to damage from griping the wing nuts and then twisting in an up or down motion. Also the larger wing nuts can be cumbersome in the tight quarter instrument setup, and setup time can increase as instruments are setup and then reset up after tuning and adjusting requires space to get into specific places.

An additional requirement is the obscure angle settings and close quarters that some percussion instrument wing nuts, adjustment and tuning adjusters devices allow. While some ratchets and moment arms are functional, purchase cannot be found and they cannot be used in percussion instrument allowed spaces for adjustment and tuning.

What is needed is a small practical yet multipurpose tool which can be used to adjust and tune musical instruments in tight quarters without added complications of large tool sets, instrument reset up, and makeshift manual solutions which may damage the instruments.

### SUMMARY

The present invention discloses an combination drum/percussion hardware wing nut adjustment tool and tuning key characterized by a cylinder, larger on one end then the other, tapering to the middle section, with a small rod passing thru the middle of the cylinder to be used for leverage. The small rod has either a pin or a washer and screw at each end to prevent the rod from extending past the rod dimension. The large end of the cylinder has two sets of open ended slots, a large set and a small set of slots. These are a some optimal angle set to handle a variety wing nut thickness and sizes. The cylinder tapers down to a smaller end, which contains a hexagon shaped counter sunk interior for extension or socket mating bars. In an embodiment, the invention the leverage slidable cross rod contains a counter sunk square hole at one end that can be fitted on any standard musical drum lug nut, for tuning drum heads, and also for other applications that use similar size nut or bolt. In another embodiment the user can utilize a socket style wrench at one end of the tool that can be used for tuning heads on standard percussion instruments such as congas, bongos, timbales, nut or bolt of fitting size.

### BRIEF DESCRIPTION OF DRAWINGS

FIG. 1 is an isometric view of the combination wingnut key tool in an embodiment of the invention.

FIG. 2 is an end view of the combination wingnut key from the wing nut socket side in an embodiment of the invention.

FIG. 3 is a side view of the combination wingnut key with a hexagon center rod in accordance with an embodiment of the invention.

FIG. 4 is a front view of the small diameter of the combination wingnut key with a hexagon socket end in accordance with an embodiment of the invention.

FIG. 5 is a side view of an axially hexagonal center cross rod with square socket end in accordance with an embodiment of the invention.

FIG. 6 is a side view of an axially oval center cross rod square socket end in accordance with an embodiment of the invention.

FIG. 7 is a perspective view drawing of the ratchet all-in-on wing nut socket tuning tool in accordance with an embodiment of the invention.

FIG. 8 is a perspective view drawing of an all-in-on wing nut socket tuning tool and extensions in accordance with an embodiment of the invention.

### DETAILED DESCRIPTION

Specific embodiments of the invention will now be described in detail with reference to the accompanying figures.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

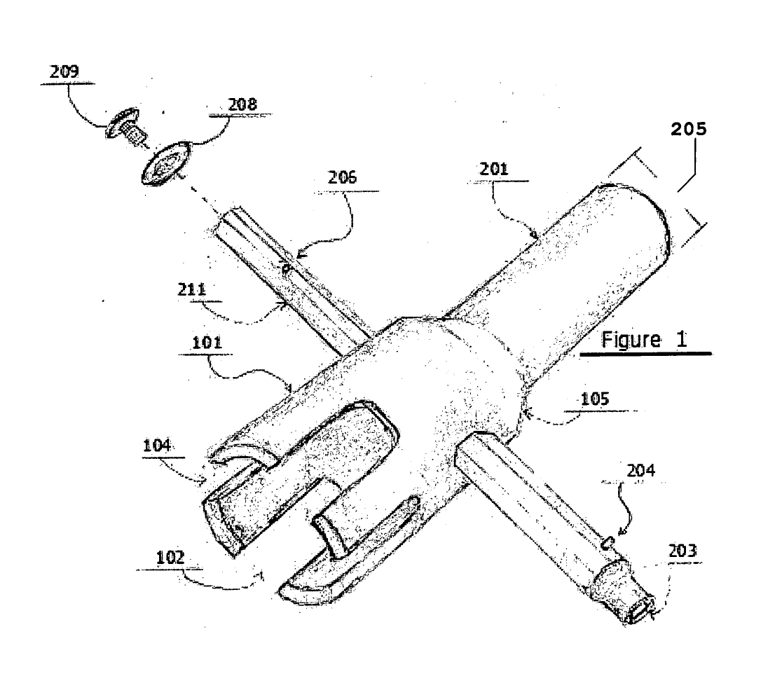

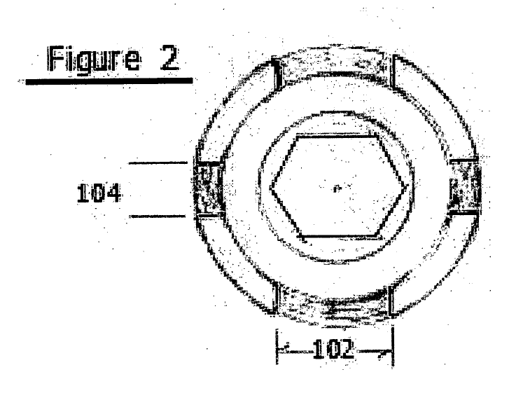

Referring to FIG. 1, a preferred embodiment is represented in an combination wing nut-socket-key and is comprised of cylinder body 201 and center cross rod 211. Center rod 211 slides freely through and in some embodiments is perpendicular to the cylinder body 201 radial center. The cross rod 211 is free to slide adjust to the users hand for several benefits. Tight spaces in the adjustment of musical instruments prevent long leverage arms from some applications, hear a slidable center rod moment arm for a couple works where a long ratchet moment arm will not fit. There are at least two sets of slots on the large cylinder body 201 end wing socket, wing slot 102 and wing slots 104 forming a wing nut socket at the tapered 105 to large end of cylinder body 201, radial to the cylinder body 201 and extending parallel to the cylinder body 201 axis.

Within cylinder body 201 each set of slots, wing slots 102 and wing slots 104 are of varying width and length to accommodate different size wing nuts. In FIG. 1, wing slots 102 and wing slots 104 are each a different width and same length. A wing nut inserted through the opposed sides of a pair of slots 102 104 can be adjusted by applying a torque to the center rod 211.

In an embodiment of the invention, the center rod 211 is freely slidable through the cylinder body 101 at its mid section, constrained at rod 211 ends by protruding stop pin 204 at one rod 211 end and a stop washer 208 of diameter slightly larger than the center rod 211 diameter, with end screw 209 fastener to rod 211 as a rod terminator and stop washer 208 at the other end. Offset slightly from the same end as stop washer 208 is a spring loaded locking snap ball 206 for frictional holding the rod in a semi-stable position towards the one end to form a “T” for application of maximum leverage.

One end of the center rod 211 (CR) incorporating a protruding stop pin 204 is tapered to a recessed CR insert 203 which is a square slot radially centered and extending a length axially into the rod 211 from the rod end 203. The rod end square slot 203 insert mates a standard drum key which fit on a standard musical drum lug to provide purchase for tuning most musical drum heads. Although the center rod 211 in FIG. 1 is illustrated as a octagonal extruded rod, it is not limited to an octagon and any shape rod can be used.

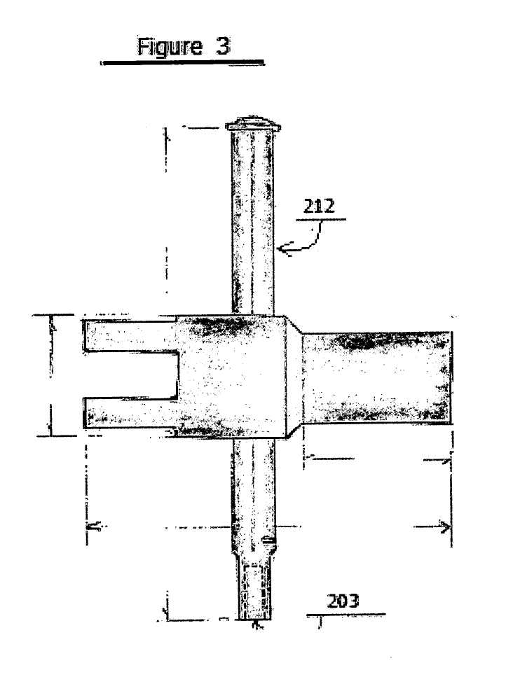

FIG. 3 is a side view of a preferred embodiment, showing the center rod 212 with the key tool end 203 counter sunk into the center rod 212 for the uses and purposes explained. The center rod geometry can vary, as illustrated in FIG. 3, the center rod 212 has a hexagon geometry, in FIG. 6 the center rod 213 is oval. Other sizes and shaped center rods can be used.

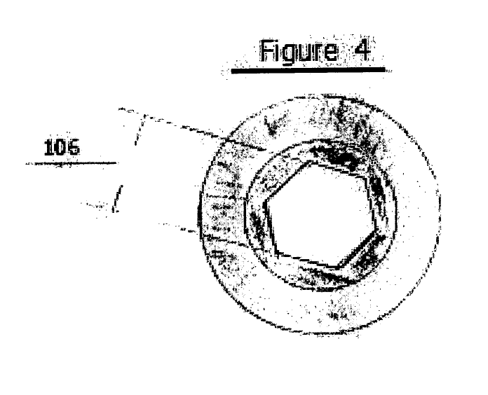

The wing nut socket end cylinder body 101 reduces in size and circumference tapering 105 to a smaller diameter cylinder 201. As illustrated in FIG. 1, center rod 211 traverses the cylinder body 101 at a 90 degree angle at its center. Both set of cut out slots are at the larger end of cylinder body 101 which form wing nut slots 102 and wing slots 104. The wing socket large diameter end tapers down to the smaller cylinder size 201 via taper 105, and a smaller hexagon can socket can be formed on the inside of the smaller diameter end cylinder 201, as illustrated in FIG. 4, hexagon inside end 106. Thus the hexagon socket end 106 is sized to adjust standard musical conga lug nuts, bongo lug nuts, timbale lug nuts, etc, providing a tuning tool for certain instruments.

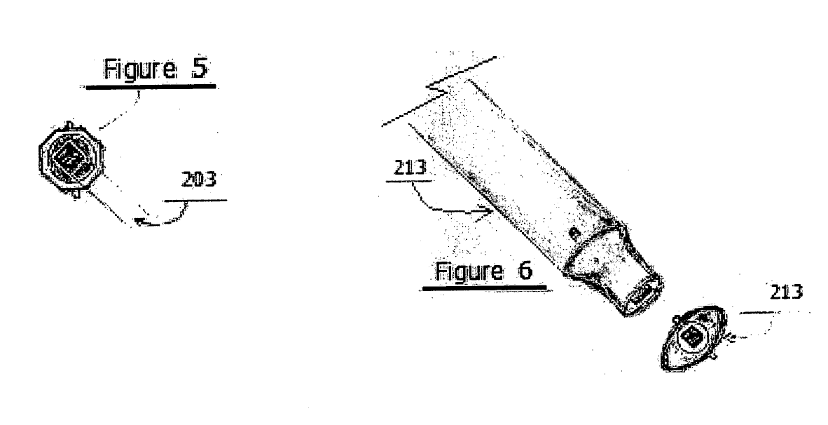

FIGS. 5 and 6 illustrate different angle renderings of the center rod socket key tool end 203 213, showing the slider stop 204 from opposite sides of the center rod 211.

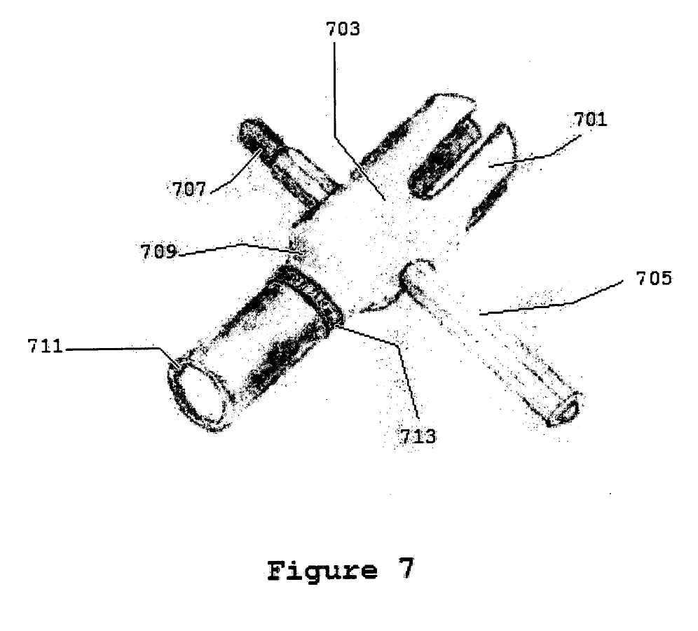

FIG. 7 is a perspective view drawing of the ratchet all-in-on wing nut socket tuning tool in accordance with an embodiment of the invention. In this embodiment, the invention tool can also be used as a standard socket wrench for any number of nuts and or bolts on other hardware. The wing nut socket 701 is conformably formed from the large cylinder diameter body 703 which tapers 709 to a ratchet 713 which is axially rotatable coupled to a smaller diameter cylindrical body 711 socket. The center cross rod 705 is slidably coupled through the large cylinder diameter body 703 providing adjustable purchase couple about the cylinder body 703 axis. Thus a hand can manually slide the cross center rod to placement clearing close quarter obstructions while continuing to tune the instrument. Thus the slidably coupled center cross rod 705 can be slipped back and forth in adjusting wing nuts or bolts and keys protruding in spaces where a normal ratchet arm would be too long, awkward or otherwise unwieldy in the space allowed.

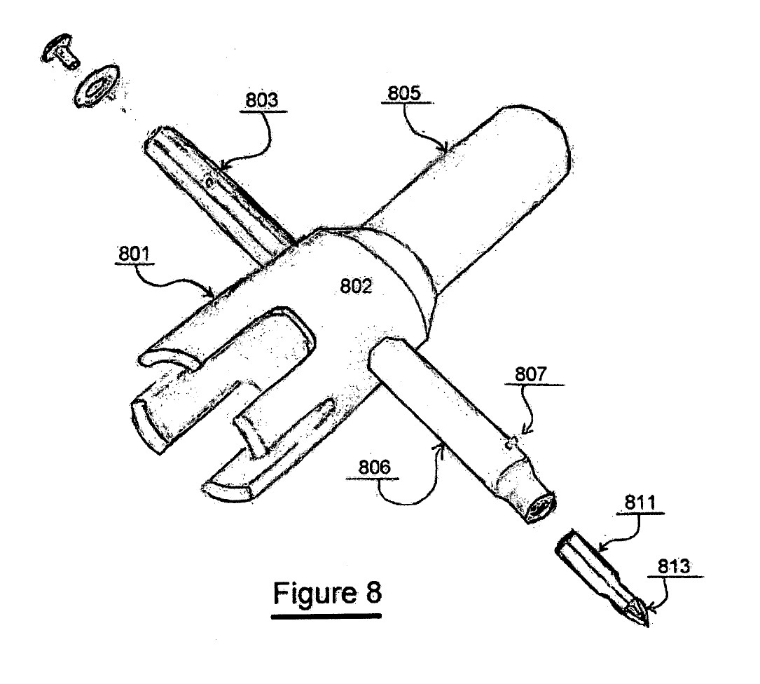

FIG. 8 is a perspective view drawing of an all-in-on wing nut socket tuning tool and extensions in accordance with an embodiment of the invention. This embodiment comprises the wing nut socket 801 on the cylindrical body 802 which tapers to a hex socket 805 on the smaller diameter tool end. The center cross rod 803 is slidably coupled at a cross axis but in the plane of the cylindrical body 802 extending through the cylinder body 802 in a shown hexagonal center rod 806 ending at a stop pin 807 and tapering to a socket for engaging interchangeable tool heads, a Phillips screw driver head 813 is shown. Thus the slidable rod cross construction facilitates many other tool functions which are not otherwise possible.

From the foregoing, it will be apparent that the combination wingnut and tuning key of the present invention provides a compact, sturdy and practical device for conveniently tightening, as well as, loosening wing nuts through out the drum, percussion and musical world. As well as, giving the artist the ability to tune the instruments, embodiments of the invention will provide a mechanical advantage tool and a typical item found inventoried in the gig bag used by most artists. This device provides a practical means for facilitating tightening and loosening of wing nuts, the tightening and loosening of various and numerous, nuts and bolts, and the tuning of numerous kinds of drums into a much easier, less harmful and effortless engagement.

Various modifications and changes may be made with regard to the foregoing detailed description without departing from the spirit of the invention.

What is claimed is:

1. An combination wing nut and tuning key tool comprising:
a cylindrical body having two diameter ends coupled with a tapered section;
a bolt socket end on the smaller diameter and a wing nut socket on the larger diameter cylinder body end;
a first and second opposed wing nut slot pairs extending out from the large cylinder diameter end forming a wing nut socket housing;
a bore extending through the wing nut socket housing and presenting an aperture at the housing end for engaging wing nuts of various sizes;
a counter sunk axially aligned bore socket at the smaller diameter end of the cylinder body, socket for receiving a bolt or key;
a cross center rod element slidably coupled through the cylinder body at a cross angle in the plane defined by rod element and cylinder body axis and;
the cross center rod element having two ends, both ends having a stop limiter means to constrain rod sliding to remain coupled to cylinder body,
whereby the sliding center rod provides hand purchase variably adjustable leverage to adjust wing nuts of various sizes or adjust bolt tightness in constrained spaces.

2. An combination wing nut and tuning key tool as in claim 1 further comprising a stop pin towards the center rod key socket end.

3. An combination wing nut and tuning key tool as in claim 1 further comprising a stop pin towards the center rod key socket end preventing the center rod from slidably uncoupling from cylindrical body element.

4. An combination wing nut and tuning key tool as in claim 1 further comprising a cross center rod element with at least one end having a stop washer.

5. An combination wing nut and tuning key tool as in claim 1 further comprising a cross center rod element with an end having a stop washer with key chain connector.

6. An combination wing nut and tuning key tool as in claim 1 further comprising a cross center rod element with an end having a socket for various interchangeable tool heads.

7. An combination wing nut and tuning key tool as in claim 1 further comprising a cross center rod element with an end having spring friction ball for resisting sliding movement while contact engaged with the cylinder body.

8. An combination wing nut and tuning key tool as in claim 1 further comprising a cross center rod element with a hollow center for inserting various tool head parts and end attachments.

9. An combination wing nut and tuning key tool as in claim 1 further comprising a cross center rod element formed from any geometrical shape extruded axially to maintain its end key and tool head counter sunk inserts.

10. An combination wing nut and tuning key tool as in claim 1 further comprising cylinder body and a cross center rod element made essentially from metal, metal alloy or other rigid material.
